(19) United States
(12) Patent Application Publication
(10) Pub. No.: US 2003/0131492 A1
(43) Pub. Date: Jul. 17, 2003

(54) Ballet/pointe shoe aerator-carrier-protector

(76) Inventor: Dennis J. Zuccaro, Canton, MI (US)

Correspondence Address: William A. Bonk, III, 5440 31st Street, N.W., Washington, DC, 20015, US

(21) Appl. No.: 10/342,356

(22) Filed: Jan. 15, 2003

Related U.S. Application Data
(60) Provisional application No. 60/347,867, filed on Jan. 15, 2002.

(51) Int. Cl. F26B 19/00; F26B 25/06

(52) U.S. Cl. 34/235; 34/233; 34/218

(57) ABSTRACT

A preferred embodiment of the invention includes a vessel having a first end and a second end. A first cap is releasably mounted on the first end. A second cap is releasably mounted on the second end. The vessel is configured to prevent crushing and promote ventilating thereof. The first cap and/or second cap may have an aperture for ventilating the vessel. A fan may be fixed relative to, for ventilating, the vessel. The may be mounted on a cap. The fan may be energizable with a battery. A switch may provide for selectably supplying energy to the fan. If a fan is provided, a barrier may be disposed in the vessel configured to protect an object in the vessel from the fan. The barrier should have an aperture for ventilating the vessel. The invention may include a handle connected to, for carrying, the vessel.

### CROSS REFERENCE TO RELATED APPLICATION

This Application incorporates and claims the benefit of U.S. Provisional Application Serial No. 60/347,867, filed Jan. 15, 2002, by Dennis J. Zuccaro, entitled Ballet/Pointe Shoe Aerator-Carrier-Protector.

### BACKGROUND OF THE INVENTION

The invention was conceived when a dancer left her ballet pointe shoes in her dance bag on the floor of her changing room at a dance studio. Accidentally, another dancer tripped and stepped on the dance bag and the shoe therein, and destroyed the very delicate “box” located at the end of the shoe that supports the toes. Because ballet pointe shoes are expensive and must be broken in over a period of months, a need exists for protecting ballet pointe shoes.

After rigorous dancing, these pointe shoes can become quite damp with perspiration, which can lead to premature breakdown if not properly aired out. This also can cause the pointe shoes to develop an odor from the perspiration, especially when kept inside of a dance bag. A need exists for providing airflow over the shoes to keep them fresh and dry.

### SUMMARY OF THE INVENTION

The invention is a ballet/pointe shoe aerator-carrier-protector for: (1) carrying ballet shoes; (2) protecting the “box” component of the shoes, which supports the toes, from being crushed and destroyed; and (3) “airing out” the contained shoes to help eliminate unpleasant odors and the premature breakdown of the ballet shoe materials due to moisture from perspiration.

To these ends, a preferred embodiment of the invention includes a vessel having a first end and a second end. A first cap is releasably mounted on the first end. A second cap is releasably mounted on the second end. The vessel is configured to prevent crushing and promote ventilating thereof. The first cap and/or second cap may have an aperture for ventilating the vessel. A fan may be fixed relative to, for ventilating, the vessel. The fan may be mounted on a cap. The fan may be energizable with a battery. A switch may provide for selectably supplying energy to the fan. If a fan is provided, a barrier may be disposed in the vessel configured to protect an object in the vessel from the fan. The barrier may have an aperture for ventilating the vessel. The invention may include a handle connected to, for carrying, the vessel.

Another embodiment of the invention includes a vessel configured to receive an object, means for retaining an object in the vessel and means for ventilating an object in the vessel. The vessel is configured to prevent crushing of an object therein. The vessel may have a cap on an end thereof and/or second cap on the other end thereof. One or both caps may have an aperture for ventilating the vessel. A fan may be fixed relative to, for ventilating, the vessel. The fan may be mounted on one of the caps. The fan may be energizable with a battery. A switch may provide for selectably supplying energy to the fan. If a fan is provided, a barrier may be disposed in the vessel configured to protect an object in the vessel from the fan. The barrier may have an aperture for ventilating the vessel. The invention may include a handle connected to, for carrying, the vessel.

The invention provides improved elements and arrangements thereof, for the purposes described, which are inexpensive, dependable and effective in accomplishing intended purposes of the invention. Other features and advantages of the present invention will become apparent from the following description of the preferred embodiment, which refers to the accompanying drawings.

### BRIEF DESCRIPTION OF THE DRAWINGS

The invention is described in detail below with reference to the following figures, throughout which similar reference characters denote corresponding features consistently, wherein:

FIG. 1 is a plan view of an embodiment of a ballet/pointe shoe aerator-carrier-protector constructed according to principles of the invention;

FIG. 2 is a cross-sectional detail view drawn along line II-II in FIG. 1;

FIG. 3 is a side elevational view of an air/inlet/battery-holder/switch housing end cap of, from within, the embodiment of FIG. 1;

FIG. 4 is a side elevational view of the air/inlet/battery-holder/switch housing end cap of, from without, the embodiment of FIG. 1;

FIG. 5 is a cross-sectional detail view drawn along line V-V in FIG. 4;

FIG. 6 is a side elevational view of a shoe compartment end cap of, from without, the embodiment of FIG. 1;

FIG. 7 is a cross-sectional detail view drawn along line VII-VII in FIG. 6;

FIG. 8 is a side elevational view of a shoe barrier/air inlet of the embodiment of FIG. 1; and

FIG. 9 is a cross-sectional detail view drawn along line IX-IX in FIG. 8.

### DETAILED DESCRIPTION OF THE PREFERRED EMBODIMENT

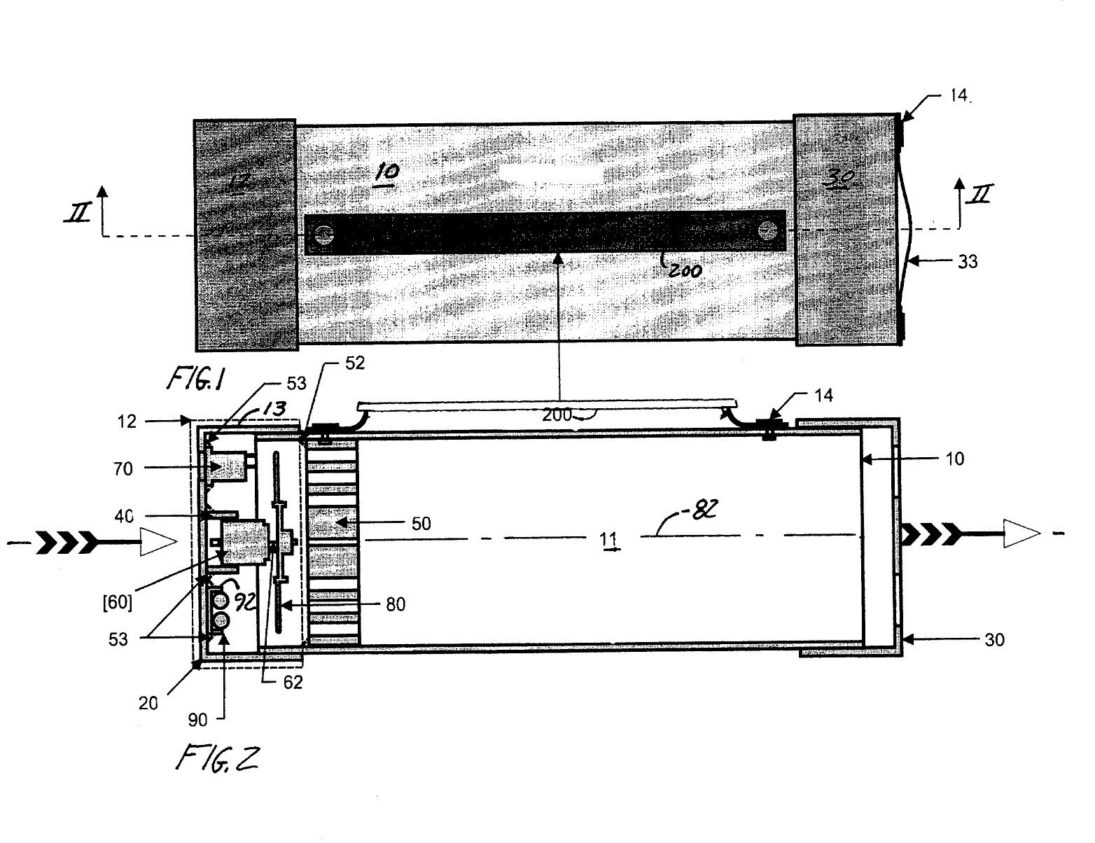

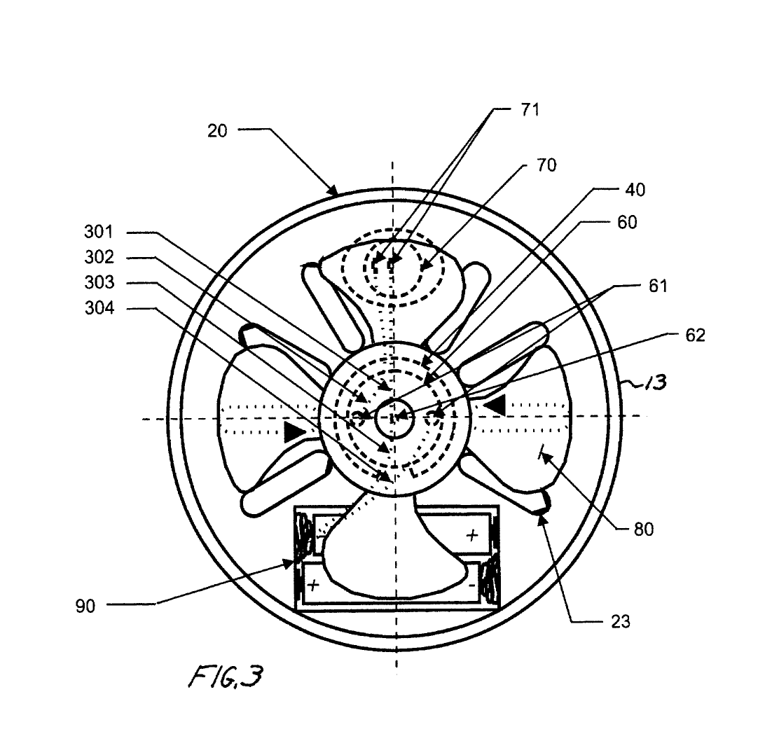

Referring to FIG. 1, a preferred embodiment of the invention includes a cylindrical vessel or tube 10 with a motor-fan/battery holder/switch housing end cap assembly 12 on one end, a shoe compartment end cap 30 on the other end, and an internal ballet/pointe shoe compartment 11, as shown in FIG. 2. Preferably, ballet/pointe shoe compartment 11 is configured to contain ballet/pointe shoes.

A basic construction of the invention may be obtained from standard 4.0-inch waste-drain-sewer poly-vinyl-chloride (WDS PVC) pipe, cut to proper length to define tube 10, and two standard 4.0-inch WDS PVC end caps to define an air inlet/switch housing end cap 20 of motor-fan/battery holder/switch housing end cap assembly 12, and shoe compartment end cap 30. Additional components may be fabricated and fitted to the pipe and end caps. Some basic machining processes may be applied to the end caps to complete the design. The components then are assembled.

Referring to FIGS. 2 and 3, motor-fan/battery holder/switch housing end cap assembly 12 includes an air inlet/switch housing end cap 20 that houses a battery holder 92, for two AAA batteries 90, a single pole single throw (SPST) rocker switch 70 and a four-bladed plastic fan 80 mounted on a shaft 62 of a dc motor 60, preferably rated from 1.0 to 3.0 volts and 8300 rpm. Air inlet/switch housing end cap 20 is secured with a slip-tight fit over tube 10, yet permits ready access to replace batteries 90 or effect repairs.

Preferably, battery-holder 92 is adhered to the bottom of air inlet/switch housing end cap 20 with a bead of high temperature hot glue 53. This is done only after circuit wires 301, 302, 303, and 304 are appropriately attached among SPST rocker switch 70, motor 60 and battery-holder 92.

The rotation of motor 60 is determined by the polarity of the electrical connection to batteries 90. Accordingly, connections for circuit wires 301, 302, 303, and 304 are made so that fan 80 will draw air in through air inlet/switch housing end cap 20 and exhaust the air from ballet/pointe shoe compartment 11 through shoe compartment end cap 30.

Referring to FIGS. 2, 4 and 5, air inlet/switch housing end cap 20 has a hole 21, preferably having a 0.5625-inch diameter, to accommodate SPST rocker switch 70. Hole 21 is located on a vertical centerline axis 24, preferably 1.5 inches above a horizontal centerline axis 22. During installation, SPST rocker switch 70 is centered into access hole 21 and adhered to the bottom of air inlet/switch housing end cap 20 with high temperature hot glue. When seated, SPST rocker switch 70 is recessed below the surface of air inlet/switch housing end cap 20 to prevent inadvertent energizing of fan 80 and discharge of batteries 90. SPST rocker switch 70 is wired between battery holder 92 and motor 60.

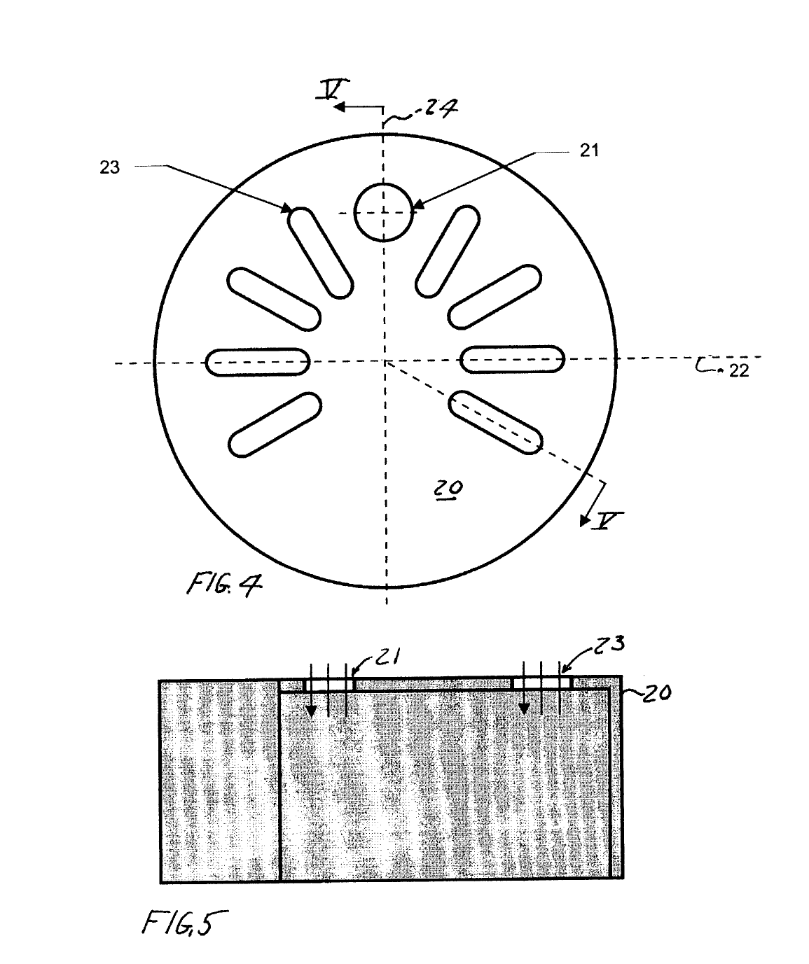

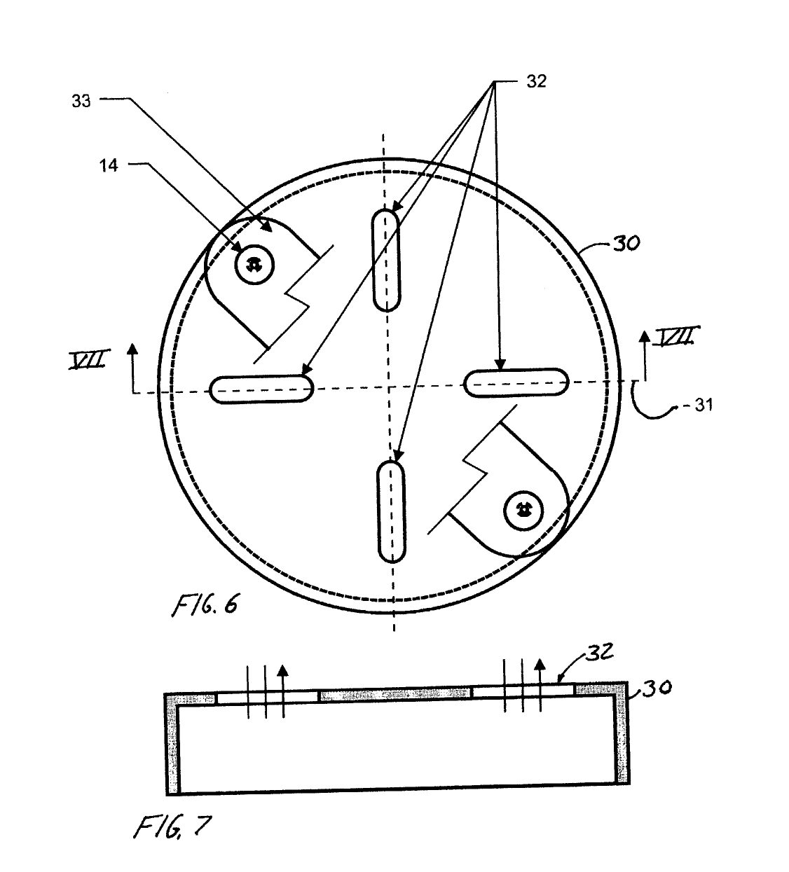

As shown in FIG. 4, circumnavigating air inlet/switch housing end cap 20 counter-clockwisely from the right hand side of centerline axis 22, preferably eight radial air inlet slots 23, preferably 0.25 inches wide and 1.0 inches long, are machined at 0, 30, 60, 120, 150, 180, 210, and 300 degrees. Air drawn into tube 10 through slots 23 of air inlet/switch housing end cap 20 via fan 80 passes through and over shoes (not shown) in ballet/pointe shoe compartment 11, then exits ballet/pointe shoe compartment 11 via air outlet slots 32 of shoe compartment end cap 30, as shown in FIG. 6 and described in greater detail below.

Referring to FIG. 2, a motor sleeve/retainer 40 houses or mounts motor 60 in motor-fan/battery-holder/switch housing end cap assembly 12. Preferably, motor sleeve/retainer 40 is formed from a 0.75-inch inner diameter PVC pipe having a 0.125-inch wall thickness cut to a 0.625-inch length. Motor sleeve/retainer 40 is split lengthwise and pried open to accept motor 60. Once motor 60 is inserted into motor sleeve/retainer 40, the split (not shown) increases in size and provides access to solder terminals 61 of motor 60, as shown in FIG. 3. Access also is created for wire leads 302, 304 from battery holder 92. Motor sleeve/retainer 40 is adhered to the bottom of air inlet/switch housing end cap 20 with appropriate adhesive and high temperature hot glue.

Referring to FIGS. 6 and 7, shoe compartment end cap 30 is secured with slip fit over tube 10, yet provides for ready access to for disposing shoes in ballet/pointe shoe compartment 11. A handle 33, connected to shoe compartment end cap 30 with rivets 14, provides for fascile assembly and disassembly of shoe compartment end cap 30 and tube 10.

Shoe compartment end cap 30 also is configured to allow airflow to exit tube 10. As shown in FIG. 6, circumnavigating shoe compartment end cap 30 counter-clockwisely from reference line 31, four radial air exhaust slots 32, preferably 0.25 inches wide and 1.0 inches long, are machined at 0, 90, 180, and 270 degrees.

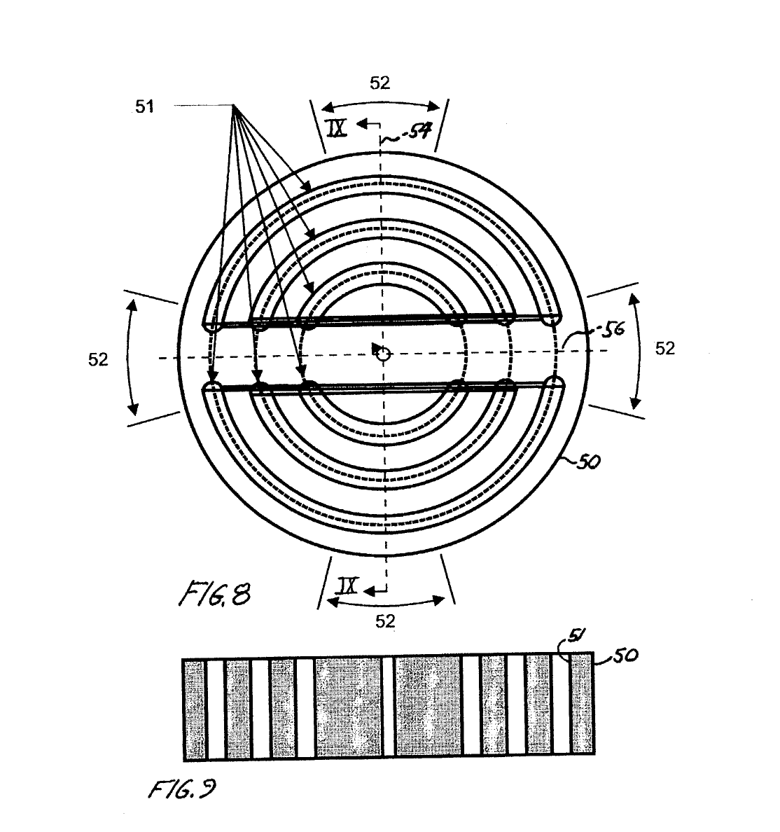

Referring to FIGS. 8 and 9, a shoe barrier/air inlet 50 isolates the shoes from fan 80 and forms one end of ballet/pointe shoe compartment 11. Shoe barrier/air inlet 50, which may be constructed of styrofoam, is inserted into tube 10 preferably one inch from the end adjacent to air inlet/switch housing end cap 20. Preferably, shoe barrier/air inlet 50 is machined to provide six 0.1875-inch circumferential slots allowing axial airflow therethrough, developed by fan 80, to enter ballet/pointe shoe compartment 11. Shoe barrier/air inlet 50 is adhered to tube 10 with beads (not shown) of low temperature hot glue at four alignments 52 located 30 degrees from perpendicular centerlines 54 and 56.

Referring to FIG. 2, ballet/pointe shoe compartment 11 is defined by tube 10, shoe compartment end cap 30 and shoe barrier/air inlet 50. Ballet shoes may be contained within ballet/pointe shoe compartment 11. End caps 20, 30 and shoe barrier/air inlet 50 are appropriately slotted so that fan 80 can create airflow along the axis 82 of tube 10. Fan 80 circulates air along the axis of tube 10 by drawing air in through motor-fan/battery-holder/switch housing end cap assembly 12 and exhausting the air out of shoe compartment end cap 30. The axial airflow “airs out” the contained shoes.

A 2-foot long carrying strap 200 is installed on tube 10, generally aligned with axis 82 and between the inboard edges of end caps 13, 30 via two 0.125-inch pop rivets 14. Carrying strap 200 makes ballet/pointe shoe aerator-carrier-protector more convenient to carry.

With the invention described above, a dancer may carry ballet shoes, whether pointe shoes or standard ballet slippers, and protect the delicate “box” of the shoes from crush. Once the dancer is done dancing, the container can be used to “air out” the shoes with the circulation fan. This will provide the dancer the ability to keep their shoes fresh and dry.

The invention is not limited to the particular embodiments described herein, rather only to the appended claims

I claim:

1 Carrier comprising:
a vessel having a first end and a second end;
a first cap releasably mounted on said first end; and
a second cap releasably mounted on said second end;
wherein said vessel is configured to prevent crushing and promote ventilating thereof.

2 Carrier of claim 1, wherein said first cap and/or said second cap have an aperture for ventilating said vessel.

3 Carrier of claim 1, further comprising a fan fixed relative to, for ventilating, said vessel.

4 Carrier of claim 3, wherein said fan is mounted on said first cap.

5 Carrier of claim 3, wherein said fan is energizable with a battery.

6 Carrier of claim 3, further comprising a switch for selectably supplying energy to said fan.

7 Carrier of claim 3, further comprising a barrier, disposed in said vessel, configured to protect an object in said vessel from said fan.

8 Carrier of claim 7, wherein said barrier has an aperture for ventilating said vessel.

9 Carrier of claim 1, further comprising a handle connected to, for carrying, said vessel.

10 Carrier comprising:
a vessel configured to receive an object;
means for retaining an object in said vessel; and
means for ventilating an object in said vessel;
wherein said vessel is configured to prevent crushing of an object therein.

11 Carrier of claim 10, wherein said vessel has an end, further comprising a cap on said end.

12 Carrier of claim 11, wherein said vessel has a second end, further comprising a second cap on said second end.

Carrier of claim 11, wherein said cap has an aperture for ventilating said vessel.

14 Carrier of claim 13, wherein said vessel has a second end, further comprising a second cap on said second end, wherein said second cap has a second aperture for ventilating said vessel.

15 Carrier of claim 10, further comprising a fan fixed relative to, for ventilating, said vessel.

16 Carrier of claim 15, wherein said vessel has an end, further comprising a cap on said end, wherein said fan is mounted on said cap.

17 Carrier of claim 15, wherein said fan is energizable with a battery.

18 Carrier of claim 15, further comprising a switch for selectably supplying energy to said fan.

19 Carrier of claim 15, further comprising a barrier, disposed in said vessel, configured to protect an object in said vessel from said fan.

20 Carrier of claim 19, wherein said barrier has an aperture for ventilating said vessel.

21 Carrier of claim 10, further comprising a handle connected to, for carrying, said vessel.
